(19) United States
(12) Patent Application Publication
(10) Pub. No.: US 2014/0124490 A1
(43) Pub. Date: May 8, 2014

(54) APPARATUS AND METHOD FOR CUTTING WITH A LASER ARRAY

(71) Applicant: GALLUS DRUCKMASCHINEN GMBH, Langgoens-Oberkleen (DE)

(72) Inventor: DIETER BANGEL, HUETTENBERG (DE)

(73) Assignee: GALLUS DRUCKMASCHINEN GMBH, Langgoens-Oberkleen (DE)

(21) Appl. No.: 14/071,850

(22) Filed: Nov. 5, 2013

(30) Foreign Application Priority Data
Nov. 5, 2012 (DE) 102012021723.4

(51) Int. Cl. B23K 26/38

(52) U.S. Cl. CPC B23K 26/38
USPC 219/121.72; 219/121.67

(57) ABSTRACT

An apparatus and a method are provided for cutting, cutting-out and perforating web or sheet substrates. The apparatus has a laser cutting device disposed above or below a transport plane for processing a substrate. The laser cutting device includes at least one laser array extending over the width of the substrate and having individually drivable lasers. The laser array is composed, in particular, of a plurality of individual arrays. The lasers are, in particular, constructed as vertical-cavity surface-emitting lasers. In this way, processing of the substrate at high transport speeds is made possible.

### CROSS-REFERENCE TO RELATED APPLICATION

This application claims the priority, under 35 U.S.C. §119, of German Patent Application DE 10 2012 021 723.4, filed Nov. 5, 2012; the prior application is herewith incorporated by reference in its entirety.

### BACKGROUND OF THE INVENTION

### Field of the Invention

The invention relates to an apparatus for cutting, cutting-out and perforating web-shaped or sheet-shaped substrates, in particular for producing folding boxes or labels, including a transport device for transporting the substrate in a transport plane in a transport direction, a laser cutting device disposed above or below the transport plane for processing the substrate and a machine control system for driving at least the transport device and the laser cutting device. The invention also relates to a method for cutting, cutting-out and perforating web-shaped or sheet-shaped substrates, in particular for producing folding boxes or labels, using the apparatus.

It is known, during the production of folding boxes or labels, to punch out the individual folding boxes or labels from web or sheet substrates. Mechanical punching devices, such as rotary punches and flat-bed punches, for example, are used for that purpose. Alternatively, it is also known to make the cut with a laser. Thus, International Application No. WO 02/14069 A1, corresponding to U.S. Pat. No. 6,592,693, discloses a device and a method for punching out self-adhesive labels by using a laser. In that case, many holes produced in the substrate by the laser are aligned in a row to form a cutting line.

International Application No. WO 99/29496 A1 discloses an apparatus and a method for processing folding boxes, in which creasing lines are introduced into a respective folding box by using a laser and subsequently represent folded edges of the folding box. Likewise, it is known to punch out folding boxes by using a laser apparatus. In that case, the laser beams are aimed at the web or sheet substrates by motorized tilting mirror deflection systems and there travel over the cutting lines or creasing lines to be produced.

The disadvantage of such methods and apparatuses is the large amount of mechanical and control expenditure. That is associated with high costs, high integration effort and a large amount of required space. Furthermore, it is not possible to achieve high production speeds in such systems. The processing speeds of known individual-beam laser systems lie considerably below processing speeds of known narrow-web rotary presses. If the cutting processing is to be carried out in-line in order to print the web or sheet substrates, then as a rule the printing speed has to be reduced. It is further disadvantageous that motor-driven mirror-deflected individual beam laser systems have a limited working area due to a limited projection area, and adaptation to different web widths or sheet formats of the substrate can only be implemented with difficulty.

### SUMMARY OF THE INVENTION

It is accordingly an object of the invention to provide an apparatus and a method for cutting, cutting-out, creasing and perforating web or sheet substrates with a laser array, which overcome or at least reduce the hereinafore-mentioned disadvantages of the heretofore-known apparatuses and methods of this general type, in which the apparatus can be produced economically and in which the method permits a high processing speed.

With the foregoing and other objects in view there is provided, in accordance with the invention, an apparatus for cutting, cutting-out, creasing and/or perforating web or sheet substrates, in particular for producing folding boxes or labels. The apparatus comprises a transport device for transporting the substrate in a transport plane, a laser cutting device disposed above or below the transport plane for processing the substrate, and a machine control system for driving at least the transport device and the laser cutting device. The laser cutting device has at least one laser array extending over the width of the substrate, i.e. transversely with respect to the transport direction, with individually drivable lasers. It is particularly advantageous if the lasers are constructed as vertical-cavity surface-emitting lasers (VCSEL). Advantages result from the simple construction of the laser array, which permits integration in limited spaces and sharply reduces the mechanical and control effort. The advantage with using VCSEL is the high reliability and longevity thereof.

The laser array can preferably be formed from a plurality of individual arrays. It is advantageous in this case that the VCSEL arrays are very accurate in their geometric form and can be produced economically, which makes it possible to position individual arrays accurately in relation to one another. Thus, a plurality of the VCSEL individual arrays can be combined to form a modular larger array. It is advantageous that a laser array can be built up over the entire substrate width. It is thus possible to process substrates for the production of folding boxes or labels over the entire substrate width at high production speeds.

In a particularly advantageous and therefore preferred development of the apparatus according to the invention, the laser array has a plurality of individual arrays disposed beside one another transversely with respect to the transport direction. The laser array can also have a plurality of individual arrays disposed after one another in the transport direction. In an advantageous development, the individual arrays are disposed offset in relation to one another. It is particularly advantageous if the laser array includes a plurality of individual arrays disposed beside one another and offset after one another. As a result of this offset configuration and the large number of individual laser light sources, overlapping of the laser light sources is produced within the laser array. Until a defective individual array is replaced, the adjacent laser light sources can thus perform the task of the defective individual array during the processing of the substrate. Even with a non-offset configuration of the individual arrays, the advantage is that the arrays can be replaced simply and economically in the event of a defect.

In an advantageous development of the apparatus according to the invention, the laser cutting device has optics disposed between the laser array and the transport plane. This can be implemented, for example, in such a way that individual laser beams are focused, in order to achieve a partial increase in power. Thus, a respective individual array can be constructed, in particular, as a coherently coupled diode-laser emitter array, which provides high power and a high power density.

In an advantageous embodiment of the apparatus according to invention, the machine control system thereof has a workflow link, a standard interface and/or an interface for the entry of cutting data. In this case, cutting data means the specification of the geometry and position on the substrate of the cuts, cut-outs, creasing lines or perforations to be made. The cutting data can, for example, already be present from the pre-press stage.

In an advantageous embodiment of the apparatus according to the invention, the machine control system thereof is connected to a camera aimed at the substrate, in particular a CNN camera. The camera is disposed upstream of the laser cutting device and is used to detect elements, i.e. individual printed images, blanks or labels, on the substrate. In this case, detection of the edges is carried out, so that, by using the laser cutting device, processing of the substrate can automatically be carried out in the correct positions.

Edges can be extracted from gray value images by using gradient filters (e.g. Sobel filters) and stored in gradient images. For each image point, the gradient images contain information about the thickness (magnitude) and the direction of an edge at the position of the image point. This information can be used to follow edges along the direction thereof (tracking). Therefore, the pixel-based edge information is transformed into list representations. In a subsequent evaluation, the contour lists can then be processed further as objects.

During the tracking of edges, secondary conditions relating to the geometric shape of the edge to be extracted can be imposed, e.g. that the edge points tracked are to form a straight line. Then, only points which satisfy this condition are taken into account during the tracking. The tracking then no longer transforms edge regions into list representations but into geometric shapes, for example straight-line segments. Further examples of geometric shapes are circles and ellipses.

With the objects of the invention in view, there is concomitantly provided a method for cutting, cutting-out, creasing and/or perforating web or sheet substrates, in particular for producing folding boxes or labels, in particular by using an apparatus as described above, which comprises moving the substrate past a laser array having individually drivable vertical-cavity surface-emitting lasers (VCSEL) and processing the substrate, i.e. providing it with cuts, trims, cut-outs, creasing lines and/or perforations. In this way, processing at high transport speeds of the substrate is made possible.

The above-described invention and the above-described advantageous developments of the invention also represent advantageous developments of the invention in any desired combination with one another.

Other features which are considered as characteristic for the invention are set forth in the appended claims.

Although the invention is illustrated and described herein as embodied in an apparatus and a method for cutting with a laser array, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, perspective view of a cutting apparatus according to the invention;

FIGS. 2A-2C are respective enlarged plan, end-elevational and side-elevational views of a laser cutting device; and

FIGS. 3A-3B are further enlarged perspective views of a laser array in two alternative configurations.

### DETAILED DESCRIPTION OF THE INVENTION

Referring now in detail to the figures of the drawings, in which mutually corresponding elements and components are provided with the same designations,

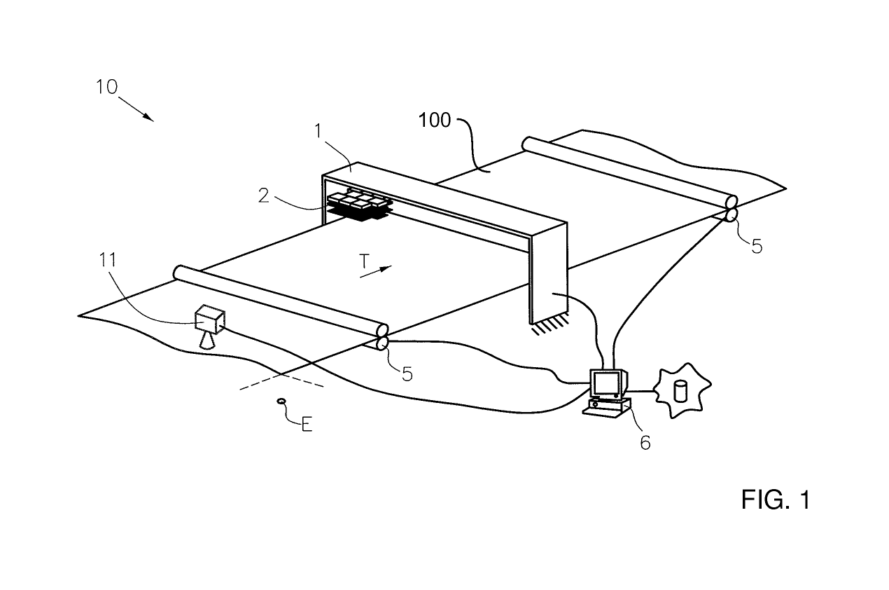

and first, particularly, to FIG. 1 thereof, there is seen a cutting apparatus 10 for processing a web substrate 100. The cutting apparatus 10 has a laser cutting device 1, a transport device 5 and a machine control system 6. The web substrate 100 is moved past the laser cutting device 1 in a transport direction T by the transport device 5. In this case, the substrate 100 can be processed by the laser cutting device 1 in a transport plane E, for example it can be provided with cut-outs, incisions, contour cuts or creasing lines. In this case, the processing is carried out by a laser array 2 belonging to the laser cutting device 1. The required cutting data for driving the laser array 2 can be stored in the machine control system 6, entered into the latter or procured by the latter through an appropriate workflow link.

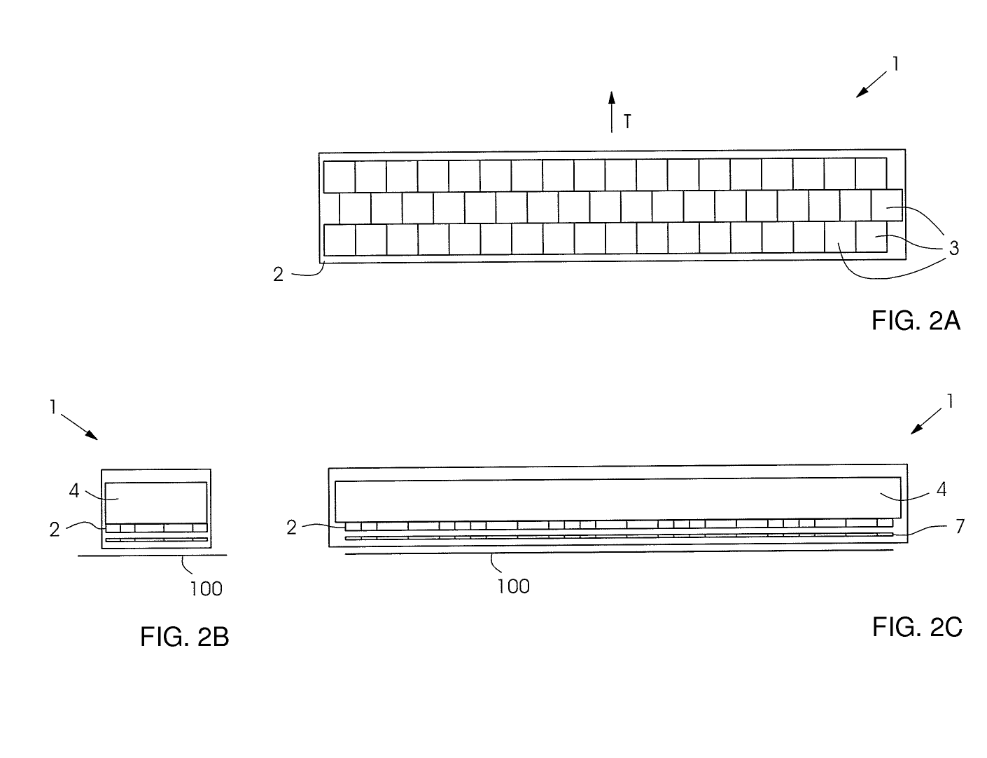

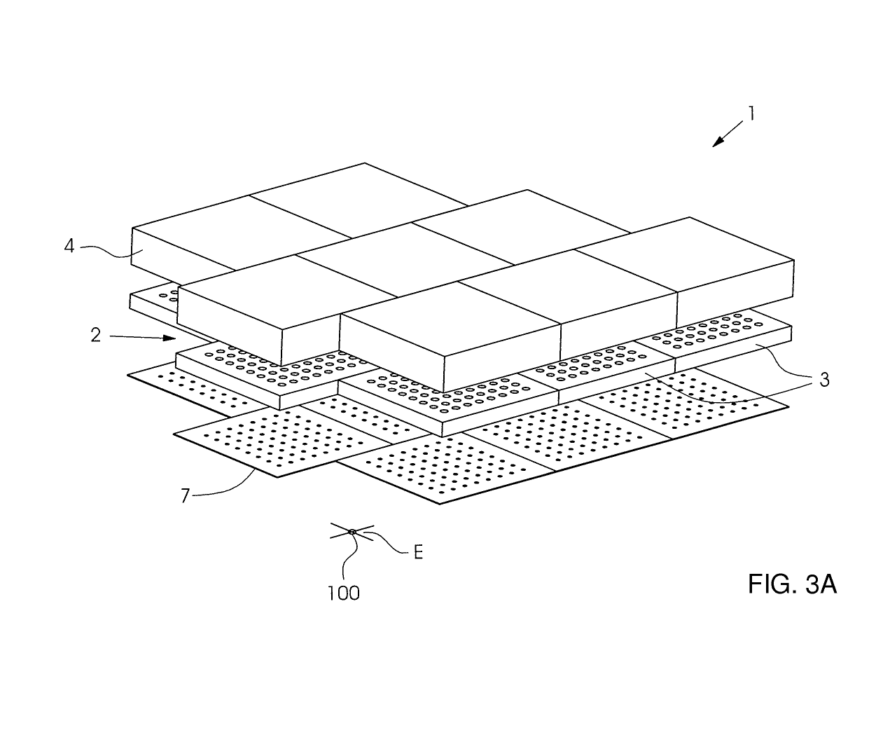

The structure of the laser cutting device 1 is illustrated in more detail in FIGS. 2A, 2B and 2C. The laser array 2 is built up from a plurality of individual arrays 3 with VCSEL lasers, in which a plurality of individual arrays 3 are disposed both after one another in the transport direction and beside one another transversely with respect to the transport direction. As viewed in the transport direction T, the individual arrays 3 are fitted offset in relation to one another. The individual arrays 3 are received by a housing 4, in which a drive system of a respective individual laser of an array is also accommodated. Optics 7 are provided between the individual arrays 3 and a substrate 100 to be processed.

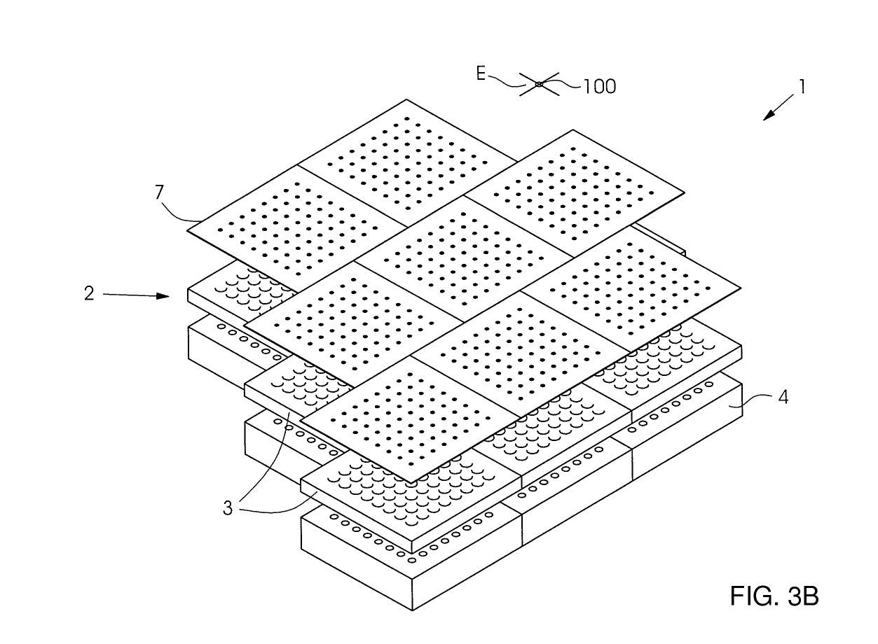

FIGS. 3A and 3B show the structure of the laser cutting device 1 in detail. The laser array 2 of the laser cutting device 1 includes a plurality of individual arrays 3 with VCSEL lasers. A respective individual array 3 is assigned a housing 4 with integrated laser drive system and optics 7. The optics 7 are constructed in this case as micro lens optics, which means that a respective individual laser beam is assigned its own optics. In addition, a controllable, non-illustrated micro-mirror array could also be connected upstream, in order to increase the resolution or the point density of the laser cutting device 1. In the structural variant of FIG. 3A, the laser cutting device 1 is located above the transport plane E in which a substrate 100 is moved. In the structural variant of FIG. 3B, the configuration has been reversed, so that the laser cutting device 1 is located below the transport plane E in which a substrate 100 is moved. In a third, non-illustrated structural variant, provision can also be made for laser cutting devices 1 to be disposed respectively above and below the transport plane E, in order to be able to process respective substrates 100 both from above and from below.

The machine control system 6 can, moreover, be connected to a camera 11 aimed at the substrate 100, in particular a CNN camera. The camera 11 is disposed upstream, as seen in the transport direction T, of the laser cutting device 1 and is used to detect printed elements, i.e. individual printed images, blanks or labels, on the substrate 100. The required computing operations are carried out in the machine control system 6. In this case, detection of edges is carried out, so that, by using the laser cutting device 1, processing of the substrate 100 can automatically be carried out at the correct positions, so that, for example, labels can be cut out.

1. An apparatus for cutting, cutting-out and perforating web or sheet substrates for producing products including folding boxes or labels, the apparatus comprising:
a transport device configured to transport a substrate in a transport plane in a transport direction;
a laser cutting device disposed above or below said transport plane and configured to process the substrate, said laser cutting device including at least one laser array extending over a width of the substrate and having individually drivable lasers; and
a machine control system configured to drive at least said transport device and said laser cutting device.

2. The apparatus for cutting, cutting-out and perforating web or sheet substrates according to claim 1, wherein said lasers are vertical-cavity surface-emitting lasers.

3. The apparatus for cutting, cutting-out and perforating web or sheet substrates according to claim 1, wherein said at least one laser array has a plurality of individual arrays disposed beside one another transversely relative to said transport direction.

4. The apparatus for cutting, cutting-out and perforating web or sheet substrates according to claim 1, wherein said laser array has a plurality of individual arrays disposed one after the other in said transport direction.

5. The apparatus for cutting, cutting-out and perforating web or sheet substrates according to claim 4, wherein said individual arrays are disposed offset relative to one another.

6. The apparatus for cutting, cutting-out and perforating web or sheet substrates according to claim 1, wherein said laser cutting device has optics disposed between said laser array and said transport plane.

7. The apparatus for cutting, cutting-out and perforating web or sheet substrates according to claim 1, wherein each respective individual array is constructed as a coherently coupled diode-laser emitter array.

8. The apparatus for cutting, cutting-out and perforating web or sheet substrates according to claim 1, wherein said machine control system has at least one of a workflow link, an interface or an interface for entry of cutting data.

9. The apparatus for cutting, cutting-out and perforating web or sheet substrates according to claim 1, which further comprises a camera disposed upstream of said laser cutting device and configured to detect elements on the substrate, said camera being connected to said machine control system.

10. A method for cutting, cutting-out and perforating web or sheet substrates for producing products including folding boxes or labels, the method comprising the following steps:
providing an apparatus including a transport device, a laser cutting device and a machine control system;
placing the laser cutting device above or below a transport plane of a substrate;
providing the laser cutting device with at least one laser array extending over a width of the substrate and having individually drivable vertical-cavity surface-emitting lasers;
driving at least the transport device and the laser cutting device using the machine control system;
moving the substrate past the laser array in the transport plane in a transport direction using the transport device; and
processing the substrate using the laser cutting device.
